(19) United States
(12) Patent Application Publication
(10) Pub. No.: US 2026/0257896 A1
(43) Pub. Date: Sep. 3, 2026

(54) MANIPULATION DEVICE AND WORK MACHINE INCLUDING THE SAME

(71) Applicant: SUMITOMO HEAVY INDUSTRIES CONSTRUCTION CRANES CO., LTD, Tokyo (JP)

(72) Inventor: Koji FUNATO, Obu-shi (JP)

(21) Appl. No.: 19/309,614

(22) Filed: Aug. 26, 2025

(30) Foreign Application Priority Data
Aug. 27, 2024 (JP) 2024-145527

(51) Int. Cl. B66C 13/56; B66C 23/36; G05G 5/03

(52) U.S. Cl. CPC B66C 13/56; B66C 23/36; G05G 5/03; B66C 2700/0371; G05G 2505/00

(57) ABSTRACT

The present invention relates to a manipulation device that manipulates a work machine which includes a manipulating member that is gripped by an operator; and a vibration unit that notifies the operator of a state of the work machine through vibration. The vibration unit constitutes a vibration system different from the manipulating member.

### CROSS-REFERENCE TO RELATED APPLICATIONS

This application claims priority to Japanese Patent Application No. 2024-145527 filed on Aug. 27, 2024, which is incorporated by reference herein in its entirety.

### BACKGROUND

### Technical Field

A certain embodiment of the present invention relates to a manipulation device and a work machine including the manipulation device.

### Description of Related Art

For example, the related art discloses a traveling state transmission unit for transmitting the vibration of a vibration device that represents a traveling state of a passenger car to a driver. The traveling state transmission unit is configured to transmit the vibration generated by the vibration device to the driver via an elastic portion provided in a manipulation unit (manipulating member) such as a steering wheel.

### SUMMARY

In order to achieve the above object, an aspect of the present invention provides a manipulation device that manipulates a work machine. The manipulation device includes: a manipulating member that is gripped by an operator; and a vibration unit that notifies the operator of a state of the work machine through vibration. The vibration unit and the manipulating member constitute different vibration systems.

Here, in the present invention, the “different vibration systems” means a configuration in which the vibration to one member propagated from a certain vibration source is not propagated to (is difficult to propagate to) the other member. For example, in a configuration in which one member and another member are physically separated from each other, the vibration is not propagated from one member to the other member. Therefore, it can be said that both members constitute different vibration systems. In addition, a configuration in which one member and another member are connected to each other via the damping member such as a spring, the vibration of one member is damped by the damping member and is difficult to propagate to the other member is also considered to constitute the different vibration systems in the present invention. In addition, in the present invention, the different vibration systems can be paraphrased as independent vibration systems.

According to the present invention, the state of the work machine can be effectively transmitted to the operator. In addition, the problems, configurations, and effects other than those described above will be apparent by the following description of the embodiments.

### BRIEF DESCRIPTION OF THE DRAWINGS

FIG. 1 is a side view of a crane.

FIG. 2 is a perspective view showing an entire cab.

FIG. 3 is a perspective view of a turning lever.

FIGS. 4A and 4B are detailed views of a turning lever, in which FIG. 4A is a front view schematically showing an internal configuration by cutting away portions of vibration units of the turning lever, and FIG. 4B is a plan view of the turning lever shown in FIG. 4A.

FIG. 5 is a block diagram showing an electrical configuration of the crane.

FIGS. 6A and 6B are diagrams showing operation patterns of vibration motors.

FIGS. 7A to 7D are diagrams showing a vibration cycle of the vibration motor according to a turning speed of a turning body.

FIGS. 8A and 8B are diagrams showing a relationship between the operation pattern of the vibration of the turning lever and an actual turning direction of the turning body.

FIGS. 9A and 9B are diagrams showing a modification example of the operation patterns of the vibration motors shown in FIGS. 8A and 8B.

FIGS. 10A and 10B are detailed views of a turning lever according to Modification Example 1, in which FIG. 10A is a front view schematically showing the turning lever, and FIG. 10B is a plan view of the turning lever shown in FIG. 10A.

FIGS. 11A and 11B show an overall configuration of a vibration unit, FIG. 11A is a view schematically showing a vertical cross section of the vibration unit, and FIG. 11B is a plan view of the vibration unit shown in FIG. 11A.

FIGS. 12A and 12B are a detailed views of a turning lever according to Modification Example 2, in which FIG. 12A is a front view schematically showing an internal configuration by cutting away portions of the turning lever, and FIG. 12B is a plan view of the turning lever shown in FIG. 12A.

FIG. 13 is a schematic diagram in which a vibration unit of a turning lever according to Modification Example 3 is enlarged.

FIGS. 14A and 14B are views showing vibration patterns of the turning lever and a winch manipulation lever.

### DETAILED DESCRIPTION

The vibration in a cab of a work machine such as a crane is greater than that in a general passenger car. Therefore, in a case where the configuration described in the related art is applied to a manipulation device of the work machine, there is a problem in that the vibration from the vibration device and the vibration of the manipulating member itself cannot be distinguished from each other and the state of the work machine cannot be effectively transmitted to the operator.

It is desirable to provide a manipulation device capable of effectively transmitting a state of a work machine to an operator.

Hereinafter, a crane as an example of a work machine according to the present invention and an embodiment of a manipulation device applied to the crane will be described with reference to the drawings.

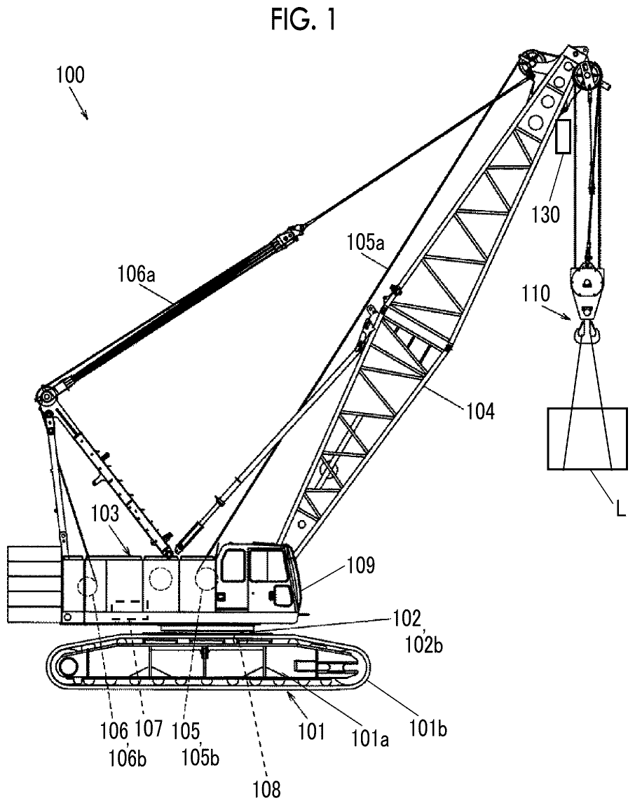

FIG. 1 is a side view of a crane 100 according to an embodiment of the present invention. The crane 100 is a crawler crane and includes an undercarriage 101, a turning body 103 turnably provided on the undercarriage via a turning ring 102 and a boom 104 pivotably supported by the turning body 103. The undercarriage 101 has a track frame 101a and a crawler 101b attached to the track frame 101a.

A cab 109 is provided on the turning body 103 and is mounted with a hoisting drum 105 which is a winch device and a rear winch drum (luffing drum) 106 in addition to an engine 107 which is a prime mover. A hoisting rope 105a is wound around the hoisting drum 105. By driving the hoisting drum 105, the hoisting rope 105a is wound or unwound and the hook 110 is lifted and lowered. A luffing rope 106a is wound around the rear winch drum 106. By driving the rear winch drum 106, the luffing rope 106a is wound or unwound and the boom 104 is lifted and lowered.

The turning body 103 is turned and driven by the turning a turning hydraulic motor 102b via the turning ring 102, the hoisting drum 105 is driven by a hoisting hydraulic motor 105b, and the rear winch drum 106 is driven by a rear winch hydraulic motor 106b.

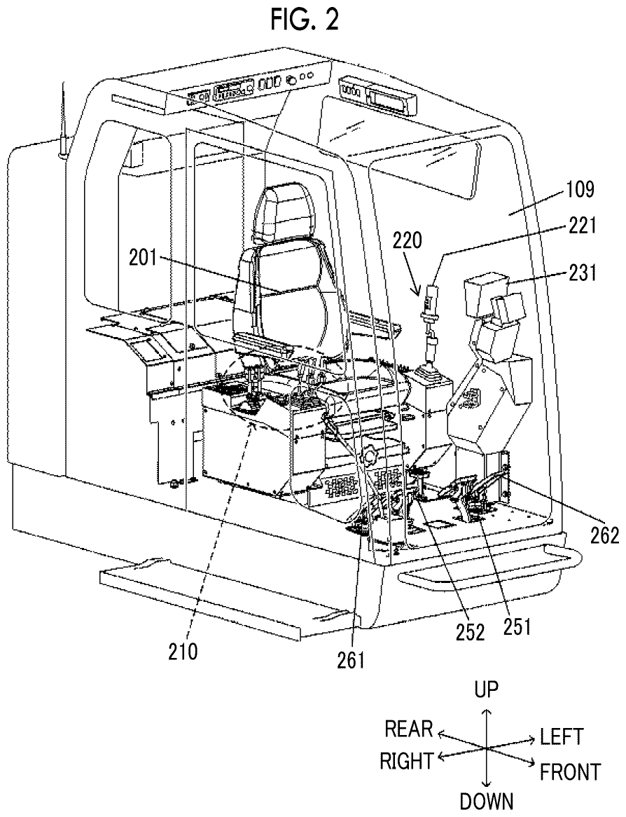

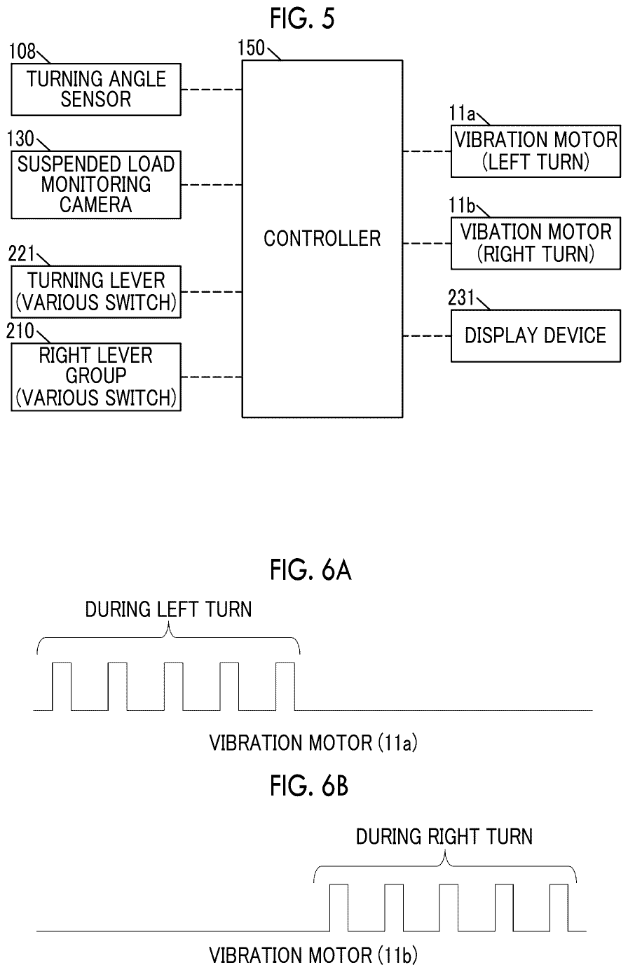

FIG. 2 is a perspective view showing the entire cab 109. As shown in FIG. 2, the cab 109 is provided with a driver's seat 201 on which an operator sits, a right lever group (traveling lever, winch manipulation lever, and the like) 210 manipulated by the operator sitting on the driver's seat 201 with his/her right hand, and a left lever device 220 which is a manipulation device according to the present embodiment and manipulated by the operator sitting on the driver's seat 201 with his/her left hand. In addition, a display device 231 (refer to FIG. 5) is provided on the left front of the driver's seat 201, and displays various information such as the operation state of the crane 100 and a warning.

A hoisting drum brake pedal 251 for braking the hoisting drum 105, a rear drum brake pedal 252 for braking the rear winch drum 106, an accelerator pedal 261 for increasing or decreasing the rotating speed of the engine 107, and a turning brake pedal 262 for braking the turning body 103 are provided on the floor of the cab 109.

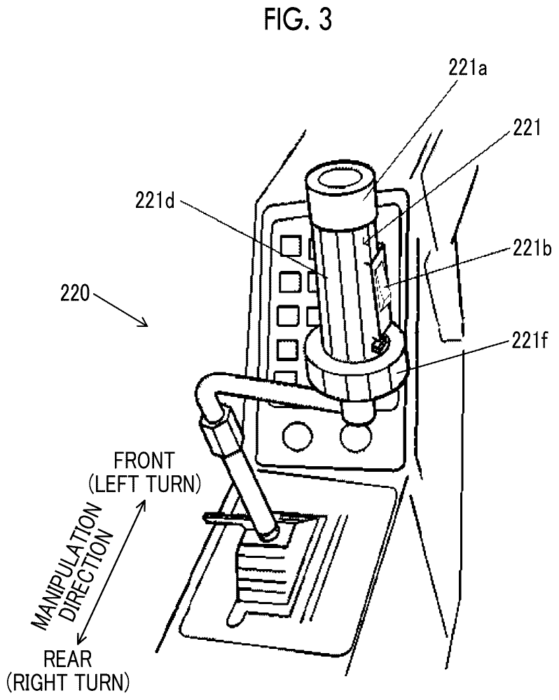

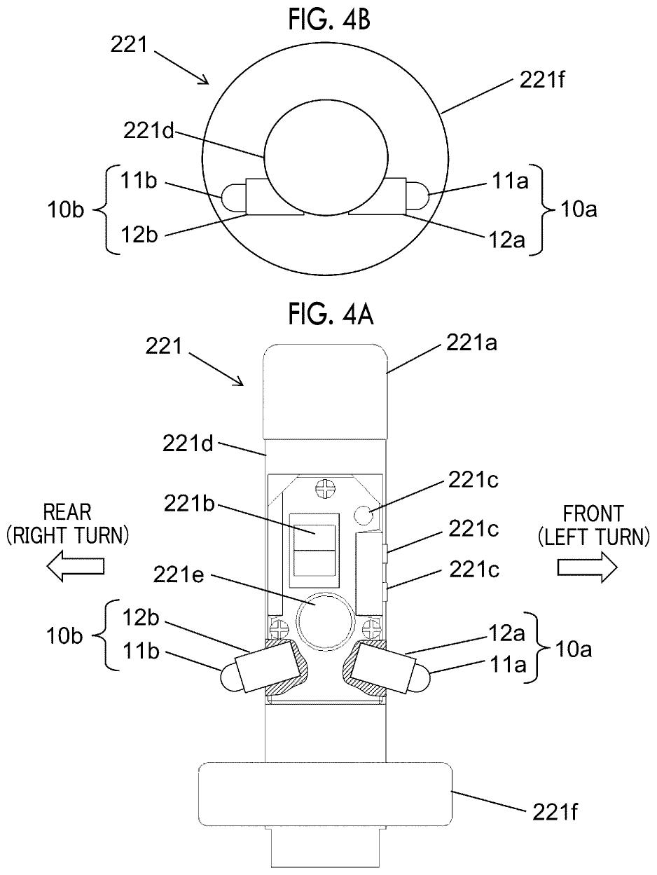

The left lever device 220 includes a turning lever 221 which is a manipulating member. The turning lever 221 is a manipulation lever for turning and driving the turning body 103 by oscillating the turning lever 221 in a front-rear direction (manipulation direction). FIG. 3 is a perspective view of the turning lever 221. As shown in FIG. 3, the turning lever 221 includes a gripping portion 221d gripped by the operator sitting on the driver's seat 201, and a flange portion 221f provided at a lower end of the gripping portion 221d. In addition, the turning lever 221 includes an accelerator grip 221a and a turning brake switch 221b, and further includes various switches 221c and a horn 221e (refer to FIGS. 4A and 4B). In FIG. 3, the illustration of the vibration units 10a and 10b to be described below is omitted.

The accelerator grip 221a is a manipulation device for increasing or decreasing the rotating speed of the engine 107 by rotating the accelerator grip clockwise or counterclockwise when viewed from above in a state in which the operator grips the gripping portion 221d with his/her left hand. The accelerator grip 221a is integrated with the turning lever 221 so that the operator can operate the turning lever 221 while operating the accelerator grip 221a with one hand. In addition, the present embodiment has a configuration in which the rotating speed of the engine 107 can be increased or decreased by operating the accelerator pedal 261 in addition to operating the accelerator grip 221a.

The turning brake switch 221b is a switch for selecting whether or not to apply turning braking that prevents the turning body 103 from turning. An example of the various switches 221c is a change-over switch for switching the operation mode to a normal mode and an eco mode. In addition, the horn 221e is a button for generating a warning sound.

Next, a detailed structure of the turning lever 221 will be described. FIGS. 4A and 4B are detailed views of the turning lever 221, in which FIG. 4A is a front view schematically showing an internal configuration by cutting away a portion of the vibration units 10a and 10b of the turning lever 221, and FIG. 4B is a plan view of the turning lever 221 shown in FIG. 4A.

In the present embodiment, when the operator grips the turning lever 221 with his/her left hand, the vibration unit 10a (first vibration unit) is provided in a region where the tip of the little finger of the operator's left-hand touches, and the vibration unit 10b (second vibration unit) is provided in a region where the base of the thumb of the operator's left-hand thumb touches. The pair of vibration units 10a and 10b include, for example, vibration motors 11a and 11b as vibrators, and cases 12a and 12b that house the vibration motors 11a and 11b. The vibration units 10a and 10b (that is, the vibration motors 11a and 11b and the cases 12a and 12b) are substantially built in the turning lever 221, and the tips of the vibration motors 11a and 11b slightly protrude from the cases 12a and 12b. Therefore, the operator can touch the tips of the vibration motors 11a and 11b with his/her hand. Also, the vibration motors 11a and 11b vibrate by allowing a current to flow through the vibration motors 11a and 11b in accordance with a command from a controller 150 (refer to FIG. 5).

The vibration motors 11a and 11b are locked to the cases 12a and 12b by a locking unit (not shown). Thus, even when the operator touches or pinches the vibration motors 11a and 11b, the vibration motors 11a and 11b are configured not to easily come off the cases 12a and 12b.

The cases 12a and 12b are made of elastic bodies such as rubber. The cases 12a and 12b are formed in a bottomed cylindrical shape, and house the vibration motors 11a and 11b therein. Since the vibration of the vibration motors 11a and 11b is damped by the cases 12a and 12b which are elastic bodies, the vibration is not easily transmitted to the gripping portion 221d of the turning lever 221. Similarly, even when the gripping portion 221d vibrates due to a signal source such as an engine, the vibration is damped by the cases 12a and 12b which are elastic bodies. Therefore, the vibration at the gripping portion 221d is not easily transmitted to the vibration motors 11a and 11b. That is, in the present embodiment, the vibration motors 11a and 11b and the gripping portion 221d are configured to have mutually different vibration systems. Thus, the vibration from each side is less likely to propagate to the other side. Therefore, when the operator touches the vibration motors 11a and 11b, only the vibrations of the vibration motors 11a and 11b can be recognized. In other words, even when the gripping portion 221d vibrates, the operator can perceptually distinguish the difference between the vibration of the gripping portion 221d and the vibration of the vibration motors 11a and 11b.

In the present invention, the vibration sources of the vibration units 10a and 10b are not limited to the vibration motors 11a and 11b. The vibration sources may be linear solenoids or rotary solenoids. That is, the type of the vibration sources is not limited as long as the vibration is transmitted to the operator's fingers. In addition, the cases 12a and 12b may be made of metal or a resin material instead of the rubber material. In this case, springs for holding the vibration motors 11a and 11b are provided inside the cases 12a and 12b, so that the springs can function as elastic bodies.

Next, an outline of an electrical configuration of the crane 100 will be described. FIG. 5 is a block diagram showing the electrical configuration of the crane 100. As shown in FIG. 5, the crane 100 includes the controller 150. The controller 150 is configured to include a calculation processing device including a CPU, a ROM and a RAM which are storage devices, other peripheral circuits, and the like, although not shown in detail. A turning angle sensor 108, a suspended load monitoring camera 130, the turning lever 221, and a right lever group 210 are electrically connected to an input side of the controller 150. In addition, the vibration motors 11a and 11b and the display device 231 are electrically connected to an output side of the controller 150.

The turning angle sensor 108 is provided in the vicinity of the turning ring 102 (refer to FIG. 1), and detects the turning angle and the turning direction of the turning body 103. The suspended load monitoring camera 130 (refer to FIG. 1) is mounted to an upper tip of the boom 104 to face downward to monitor an entire suspended load L including the hook 110. An image including the suspended load L captured by the suspended load monitoring camera 130 is input to the controller 150. Then, the controller 150 displays the input image of the suspended load L on the display device 231. In addition, manipulation signals from the manipulation levers 210 and 221 are also input to the controller 150, and the crane 100 is controlled.

In the crane 100 configured as described above, when the operator tilts the turning lever 221 forward (in the first direction), the turning body 103 turns to the left, and the turning angle sensor 108 detects the left turn and the speed thereof. In addition, when the operator tilts the turning lever 221 rearward (in the second direction), the turning body 103 turns to the right, and the turning angle sensor 108 detects the right turn and the speed thereof. The information on the turning directions and the speeds is transmitted to the controller 150, and the controller 150 drives the vibration motor 11a in the case of the left turn and drives the vibration motor 11b in the case of the right turn.

FIGS. 6A and 6B are diagrams showing operation patterns of the vibration motors 11a and 11b. For example, as shown in of FIG. 6A, when the turning lever 221 is tilted forward, the vibration motor 11a vibrates at a predetermined frequency. In this case, the vibration motor 11b is stopped (refer to FIG. 6B). Therefore, the operator can recognize that a left turn manipulation is performed by the turning lever 221 from the vibration felt at the tip of the little finger of his/her left-hand.

On the other hand, when the turning lever 221 is tilted rearward, the controller 150 drives the vibration motor 11b in response to the rearward tilt. Then, as shown in FIG. 6B, the vibration motor 11b starts vibrating. In this case, the vibration motor 11a is stopped (refer to FIG. 6A). Therefore, the operator can recognize that a right turn manipulation is performed by the turning lever 221 from the vibration felt at the base of the thumb of his/her left-hand.

In addition, the controller 150 displays the turning angle and the turning direction of the turning body 103 on the display device 231, based on the detection signal from the turning angle sensor 108. This display allows the operator to confirm the contradiction between the manipulation direction of the turning lever 221 and the actual turning direction of the turning body 103. Then, in a case where the turning direction of the turning body 103 and the manipulation direction of the turning lever 221 does not match each other, for example, in a case where the turning direction of the turning body 103 is a right turn direction even though the input of the turning lever 221 is a left turn command, the controller 150 determines that the turning body 103 is being flowed by an external factor such as wind or a sloping ground (turning flow), and changes the operation pattern in a vibration motor to a pattern different from a normal pattern. That is, the controller 150 changes the vibration pattern in the vibration motor according to the state of the crane 100.

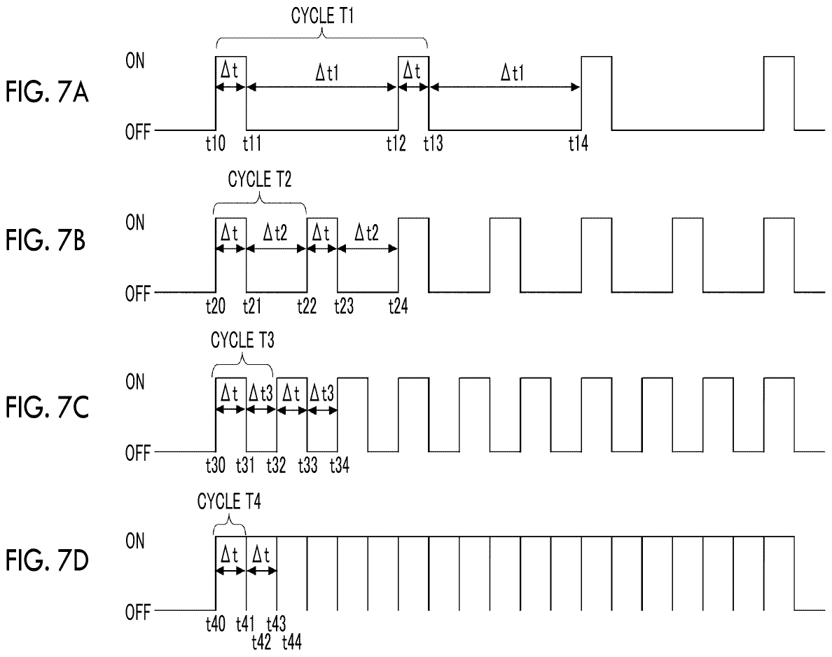

The present invention will be specifically described with reference to FIGS. 7A to 7D. FIGS. 7A to 7D are diagrams showing the vibration cycle of the vibration motors 11a and 11b according to the turning speed of the turning body 103. FIGS. 7A to 7D show the operation timing of the vibration motor 11a in a case where the turning lever 221 is tilted forward and the turning body 103 turns left, and the turning speed of the turning body 103 is increased from FIGS. 7A to 7D.

As shown in FIG. 7A, when the turning body 103 is slowly turning (the turning body 103 is turning at a low speed), the controller 150 drives the vibration motor 11a from time t10 to time t11 (that is, during Δt), and stops the driving of the vibration motor 11a from time t11 to time t12 (that is, during Δt1). The controller 150 repeats this cycle T1. The on-time Δt is, for example, about 0.2 seconds, and is set to a time during which a vibrator (weight) of the vibration motor 11a can vibrate sufficiently.

When the turning speed of the turning body 103 gradually increases, as shown in FIG. 7B, the controller 150 drives the vibration motor 11a from time t20 to time t21 (that is, during Δt), and stops the driving of the vibration motor 11a from time t21 to time t22 (that is, during Δt2). The controller 150 repeats this cycle T2. Δt2 is a time shorter than Δt1.

When the turning speed of the turning body 103 is further increased to a medium level, as shown in FIG. 7C, the controller 150 drives the vibration motor 11a from time t30 to time t31 (that is, during Δt), and stops the driving of the vibration motor 11a from time t31 to time t32 (that is, during Δt3). The controller 150 repeats this cycle T3. Δt3 is a time shorter than Δt2.

When the turning speed of the turning body 103 is a speed at which the turning of the turning body 103 is visible (that is, the turning body 103 is high-speed), as shown in FIG. 7D, the controller 150 drives the vibration motor 11a from time t40 to time t41 (that is, during Δt) and stops the driving of the vibration motor 11a from time t41 to time t42 (that is, during Δt4). However, Δt4 is almost zero. That is, in a case where the turning speed is considerably high, the vibration motor 11a is stopped for almost no time, and continues vibrating. The controller 150 repeats this cycle T4.

In this way, in the present embodiment, the vibration cycle of the vibration motor 11a is configured to be shortened (the vibration frequency is increased) from T1 to T4 as the turning speed of the turning body 103 increases. Therefore, the operator can recognize that the speed of the turning body 103 is increasing by the sense of his/her left hand. In a case where the turning speed of the turning body 103 is high (as in FIG. 7D), the operator can visually confirm the turning state of the turning body 103. Therefore, the operator may not vibrate the vibration motors 11a and 11b of the turning lever 221.

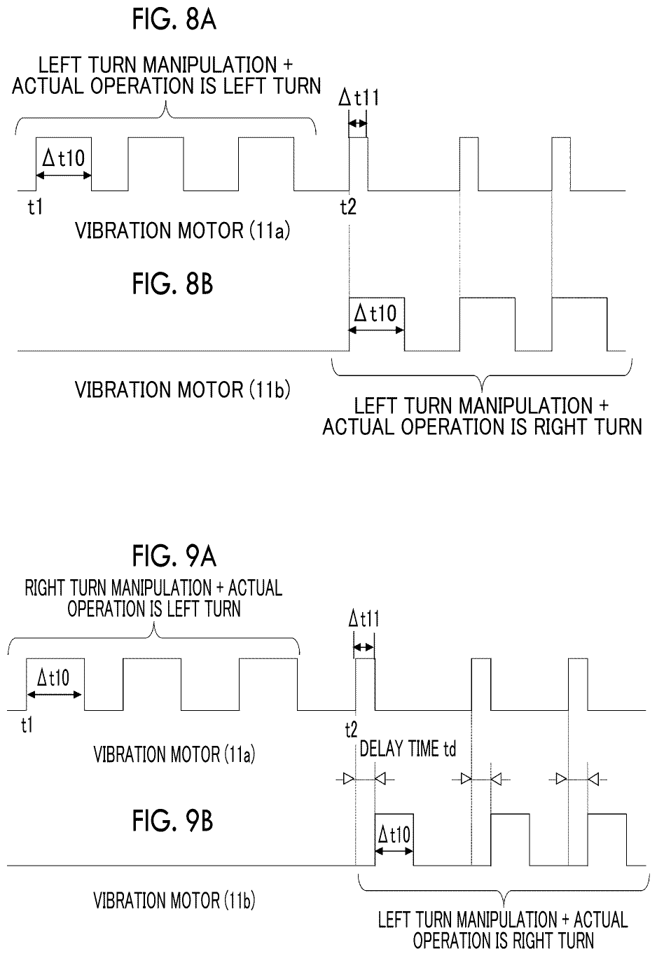

Next, the operation pattern of the vibration in the vibration motors 11a and 11b in a case where the operation of the turning lever 221 and the turning direction of the turning body 103 contradict with each other will be described. FIGS. 8A and 8B are diagrams showing a relationship between an operation pattern of the vibration in the turning lever 221 and an actual turning direction of the turning body 103.

Even when the turning lever 221 is tilted forward (left turn manipulation), it is considered that a turning flow is generated in a case where the turning direction of the turning body 103 detected by the turning angle sensor 108 is the right turn. Therefore, as shown in FIGS. 8A and 8B, the controller 150 vibrates the vibration motor 11b for an on-time Δ10 and operates the vibration motor 11a for an on-time Δt11 shorter than the on-time Δt10 of the vibration motor 11b at the timing when the actual turning direction of the turning body 103 is different from the manipulation direction of the turning lever 221, that is, at time t2, unlike a case where the turning direction of the vibration motor 11a is the same. Accordingly, the vibration motor 11b operates in a form in which the vibration lingers in the operator's left hand (particularly, the tip portion of the little finger). Therefore, the operator can feel that the turning body 103 is actually turning to the right at the base of the thumb of the operator's left hand due to the vibration. As described above, according to the present embodiment, the operation patterns of the vibration motor 11a and the vibration motor 11b are changed, so that directions can be more clearly sensed in a case where the manipulation direction of the turning lever 221 and the actual turning direction of the turning body 103 are different than in a case where both the directions are the same. In the present embodiment, for example, Δt10 is 0.5 second, and Δt11 is 0.2 second.

According to the embodiment configured as described above, the following advantageous effects can be achieved.

The vibration units 10a and 10b built in the turning lever 221 are not affected by the vibration of the gripping portion 221d (turning lever 221) and vibrate independently. Therefore, the operator can clearly distinguish the vibration of the vibration units 10a and 10b from the vibration of the gripping portion 221d. Therefore, the operation state of the crane 100 can be effectively transmitted to the operator.

In addition, in a case where the manipulation direction of the turning lever 221 and the actual turning direction of the turning body 103 are different from each other, the controller 150 causes the vibration motors 11a and 11b to vibrate in different operation patterns. Therefore, simply by gripping the turning lever 221, the operator can sense that a turning flow is generated from a change in vibration pattern. Therefore, the fact that the state of the crane 100 is different from the actual operation can be effectively transmitted to the operator.

Furthermore, since the turning direction of the turning body 103 is displayed on the display device 231, the operator can easily visually confirm whether or not the manipulation direction of the turning lever 221 and the actual turning direction of the turning body 103 match each other.

### Modification Example of Operation Pattern in Vibration Motor

FIGS. 9A and 9B show a modification example of the operation patterns of the vibration motors shown in FIGS. 8A and 8B. The example shown in FIGS. 9A and 9B is characterized in that the vibration motor 11b is driven with a delay time td later than time t2 which is the timing when the turning flow is generated. In the case of this operation pattern, since the vibration motor 11a is driven for a short on-time at time t2, the vibration is transmitted to the little finger of the left hand. Then, the vibration motor 11b is driven with a delay of time td from the timing of time t2, and the vibration is transmitted to the base of the thumb of the left hand. Therefore, the vibration motor 11b operates in a form in which the vibration lingers in the little finger of the left hand for time td, and vibration having a different on-time is transmitted to the base of the thumb of the left hand. Therefore, there is an advantage that the operator can more easily sense the contradiction between the manipulation direction and the actual turning direction of the turning body 103.

In addition, the delay time td of the vibration motor 11b is set to a time shorter than the on-time Δt11 of the vibration motor 11a at time t2. In addition, the on-time Δt10 of the vibration motor 11b is set to the same time as the on-time Δt10 of the vibration motor 11a at time t1. Then, the on-time Δt10 is set to a longer time than the on-time Δt11. The reason for this is to make the operator recognize the difference between the manipulation direction of the turning lever 221 and the actual turning direction of the turning body 103 while the vibration lingers in the operator's left hand. In this modification example, for example, Δt10 is 0.5 seconds, Δt11 is 0.2 seconds, and the delay time td is 0.1 second.

Next, various modification examples of the turning lever will be described.

### Modification Example 1

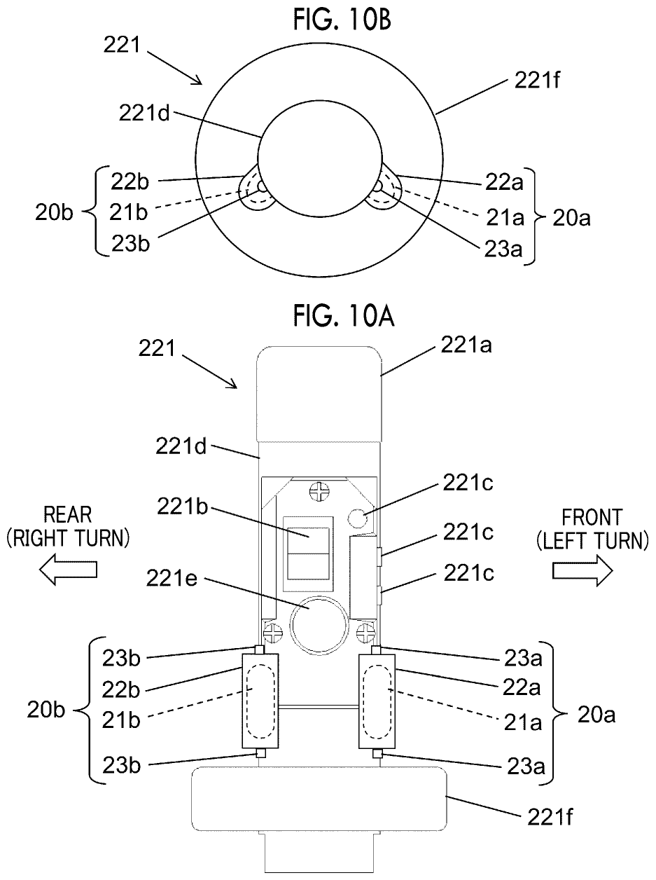

FIGS. 10A and 10B are detailed views of a turning lever according to Modification Example 1, in which FIG. 10A is a front view schematically showing the turning lever, and FIG. 10B is a plan view of the turning lever shown in FIG. 10A. As shown in FIGS. 10A and 10B, in Modification Example 1, the configurations of vibration units 20a and 20b are different from those of the above-described embodiment. Hereinafter, the differences will be specifically described.

The vibration units 20a and 20b according to Modification Example 1 are provided at a position below the gripping portion 221d and slightly above the flange portion 221f. The vibration unit 20a comes into contact with the tip of the little finger of the operator's left-hand and the vibration unit 20b comes into contact with the base of the thumb of the operator's left-hand, which are the same as the above-described embodiment.

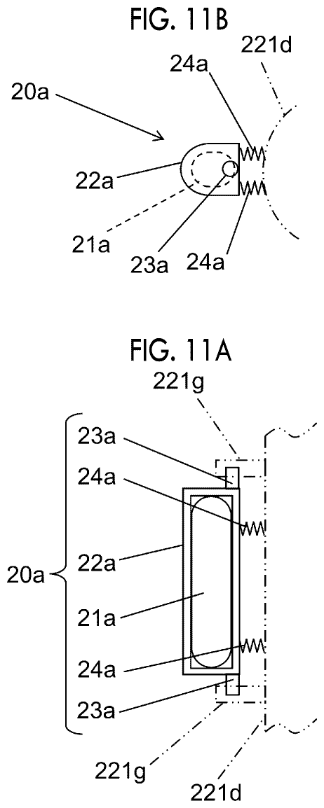

Next, the vibration units 20a and 20b will be described in detail. Since the vibration unit 20a and the vibration unit 20b have the same configuration, only the vibration unit 20a will be described here. FIGS. 11A and 11B show an overall configuration of the vibration unit 20a, in which FIG. 11A is a schematic view showing a vertical cross section of the vibration unit 20a, and FIG. 11B is a plan view of the vibration unit shown in FIG. 11A.

As shown in FIGS. 11A and 11B, the vibration unit 20a includes the vibration motor 21a which is a vibrator, and a case 22a that houses the vibration motor 21a. The case 22a is made of a resin material, and is formed in a hollow rectangular parallelepiped shape having a slightly rounded front surface.

The case 22a has a pair of upper and lower shaft portions 23b, and the pair of shaft portions 23a are pivotably supported by a pair of upper and lower shaft support portions 221g provided below the gripping portion 221d. Here, a certain gap (play) is provided between the shaft support portion 221g and the shaft portion 23b. Therefore, the shaft portion 23a is movable within a range of the gap in the shaft support portion 221g.

The vibration motor 21a is integrally fixed inside the case 22a. Therefore, when the vibration motor 21a vibrates, the case 22a vibrates accordingly. In this case, since there is the gap between the shaft portion 23a and the shaft support portion 221g, the case 22a is displaced by the amount of the gap due to the vibration. Accordingly, the vibration of the vibration motor 21a can be transmitted to the operator via the case 22a.

Furthermore, the case 22a is connected to the gripping portion 221d via a plurality of spring elements 24a (damping members). The spring element 24a may be formed of a coil spring or the like, or a part of the case 22a having flexibility may constitute the spring element 24a. The spring element 24a is for damping the vibration of the gripping portion 221d and making it difficult for the vibration to be propagated to the case 22a, and the spring element 24a causes the case 22a and the gripping portion 221d (that is, the turning lever 221) to constitute different vibration systems.

Therefore, the vibration motor 21a can transmit the vibration to the case 22a without being affected by the vibration of the gripping portion 221d. As a result, the operator can feel the vibration of the case 22a well separately from the vibration of the gripping portion 221d.

According to Modification Example 1, it is possible to achieve the same advantageous effects as those of the above-described embodiment. Moreover, since the vibration motors 21a and 21b are completely housed in the cases 22a and 22b, it is also possible to prevent the vibration motors 21a and 21b from falling off from the cases 22a and 22b.

### Modification Example 2

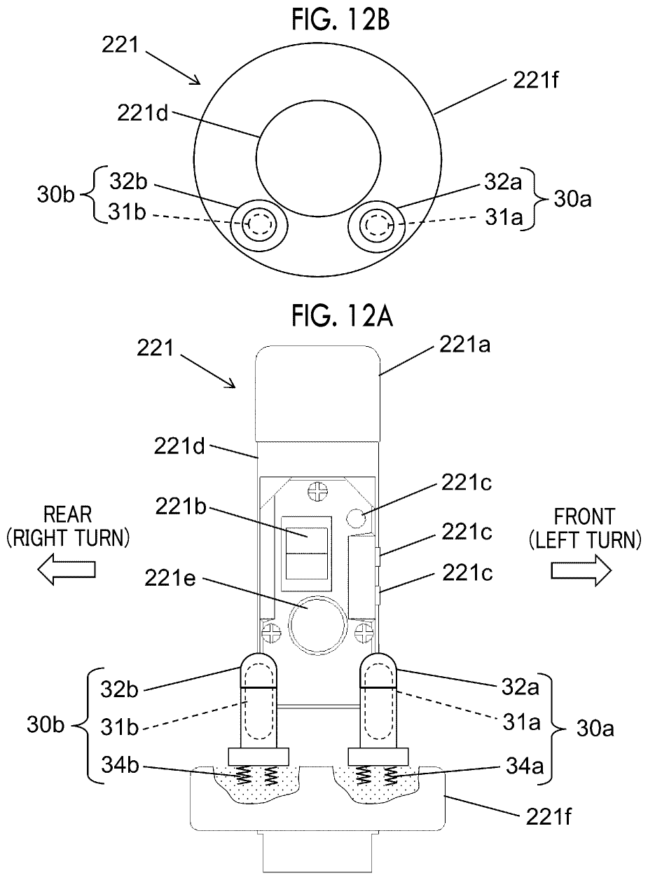

FIGS. 12A and 12B are detailed views of a turning lever according to Modification Example 2, in which FIG. 12A is a front view schematically showing an internal configuration by cutting away a portion of the turning lever, and FIG. 12B is a plan view of the turning lever shown in FIG. 12A. As shown in FIGS. 12A and 12B, in Modification Example 2, the configurations of vibration units 30a and 30b are different from those in the above-described embodiment. Hereinafter, the differences will be specifically described.

The vibration units 30a and 30b according to Modification Example 2 are characterized by being provided on an upper surface of the flange portion 221f. In addition, the tip of the little finger of the operator's left-hand comes into contact with the vibration unit 30a and the vibration unit 30b comes into contact with the base of the thumb of the operator's left-hand, which are the same as the above-described embodiment.

The vibration unit 30a includes the vibration motor 31a which is a vibrator, and the case 32a that houses the vibration motor 31a. The case 32a is made of a resin material, and is formed in a hollow cylindrical shape having a slightly rounded upper portion. The case 32a is attached to the flange portion 221f, but is slightly movable in an up-down direction (an axial direction of the turning lever 221).

The vibration motor 31a is integrally fixed inside the case 32a, and when the vibration motor 31a vibrates, the case 22a vibrates in the up-down direction accordingly. Accordingly, the vibration of the vibration motor 31a can be transmitted to the operator.

Furthermore, the case 32a is connected to the flange portion 221f via a plurality of spring elements 34a (damping members). The spring element 34a may be formed of a coil spring or the like, or a part of the case 32a having flexibility may constitute the spring element 34a. The spring element 34a is for damping the vibration of the flange portion 221f and making it difficult for the vibration to be propagated to the case 32a, and the spring element 34a causes the case 32a and the flange portion 221f (that is, the turning lever 221) to constitute different vibration systems. The vibration unit 30b is also configured similarly to the vibration unit 30a.

Therefore, the vibration motor 31a can transmit the vibration to the case 32a without being affected by the vibration of the flange portion 221f. As a result, the operator can feel the vibration of the case 32a separately from the vibration of the flange portion 221f.

According to Modification Example 2, the same advantageous effects as those of the above-described embodiment can be obtained. Moreover, since the vibration motors 31a and 31b are completely housed in the cases 32a and 32b, it is also possible to prevent the vibration motors 31a and 31b from falling off from the cases 32a and 32b.

In addition, the inside of the gripping portion 221d has many wiring lines of switches 221c, and in a case where the wiring lines of the vibration motors 31a and 31b are further housed in the gripping portion 221d, wiring design is difficult. However, in Modification Example 2, the vibration units 30a and 30b are attached to the flange portion 221f. Therefore, the wiring lines of the vibration motors 31a and 31b can be drawn into the inside of the flange portion 221f. Therefore, there is also an advantage that the degree of freedom in the wiring design is increased.

### Modification Example 3

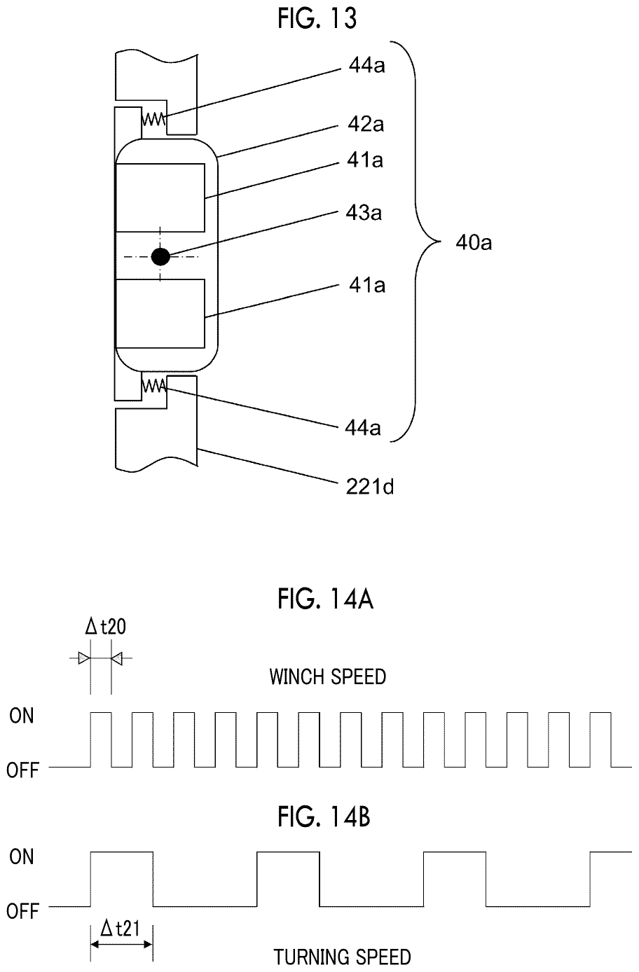

Next, a modification example of the configuration of a vibration unit will be described. FIG. 13 is a schematic diagram of a vibration unit in which a turning lever according to Modification Example 3 is enlarged. As shown in FIG. 13, the vibration unit 40a according to Modification Example 3 is characterized in that a linear vibrator is used instead of the vibration motor. Hereinafter, this feature point will be specifically described.

The vibration unit 40a according to Modification Example 3 includes a pair of linear vibrators 41a, a case 42a that houses the pair of linear vibrators 41a, and a spring element 44a provided between the case 42a and the gripping portion 221d.

The pair of linear vibrators 41a are integrally fixed to the case 42a. Therefore, the pair of linear vibrators 41a are alternately excited, and the case 42a pivots (vibrates) around a rotary shaft 43a.

The case 42a is supported by the spring element 44a (damping member), and the case 42a and the gripping portion 221d constitute different vibration systems.

Even with this configuration, it is possible to achieve the same advantageous effects as those of the above-described embodiment.

### Other Modification Examples

In the above description, the configuration of the turning lever (manipulation lever) having the two vibration units is exemplified. However, the number of vibration units is not limited to two. The number of vibration units may be determined according to the number of manipulation directions of a lever to be manipulated. For example, when the manipulation direction of a manipulation lever is four directions (front, rear, left, and right), the number of vibration units can be set to four.

In addition, the number of manipulation directions and the number of vibration units do not necessarily match each other. For example, in a case where the manipulation direction is four directions, a configuration may be adopted in which two vibration units corresponding to the front-rear direction and one vibration unit corresponding to a left-right direction are provided on a manipulation lever. In this case, the operator can accurately recognize the manipulation direction in the front-rear direction, and cannot identify the manipulation direction in the left-right direction, but can recognize whether or not an operation is performed. That is, in a case where the manipulation direction is to be recognized, the same number of vibration units as the number of manipulation directions may be provided, and in a case where only the presence or absence of the operation is to be recognized, one vibration unit may be provided.

In addition, a plurality of vibration units may be provided on a specific manipulation lever, and the operations of a plurality of the manipulation levers may be associated with each vibration unit in advance. That is, a configuration may be adopted in which the operator can recognize the operations of the other manipulation levers via the vibration unit simply by gripping the specific manipulation lever. For example, in a crane, the operator may be caused to recognize the state of the crane, such as the presence or absence of a hoisting manipulation of a winch or the presence or absence of a traveling manipulation, as one of the plurality of vibration units provided in the turning lever vibrates.

In addition, the vibration pattern is changed for each manipulation lever, so that the operator can clearly recognize the speed or the direction of a manipulation target to be manipulated by the manipulation lever. FIGS. 14A and 14B are views showing vibration patterns of the turning lever and a winch manipulation lever. In a modification example shown in FIGS. 14A and 14B, the vibration patterns of vibration motors, that is, the on-time and the off-time of the vibration motors are made different for each speed detection target. Specifically, the speed of the turning body 103, which is a speed detection target, and the hoisting/lowering speed of the hoisting drum 105, which is a speed detection target, are respectively detected, and the vibration patterns of the vibration motors provided in the corresponding manipulation levers are set to be different from each other according to the detection results thereof.

In the example shown in FIGS. 14A and 14B, the on-time of the vibration motor of the winch manipulation lever 210 is Δt20, and the on-time of the vibration motors 11a and 11b during the operation of the turning lever 221 is Δt21. For example, Δt20 is set to 0.15 seconds, and Δt21 is set to 0.3 seconds. In this case, since the vibration felt in the left hand that manipulates the turning lever 221 and the vibration felt in the right hand that manipulates the winch manipulation lever 210 have different vibration patterns, the operator can clearly recognize the states of the turning body 103 and the hoisting drum 105 from a difference in the vibrations felt in both hands.

In addition, even in a case where a plurality of vibration motors are provided in a grip of a four-direction manipulation lever in which a turning manipulation and a hoisting drum operation are integrated into one, when the operation of FIGS. 14A and 14B is performed, the operator can clearly recognize the speed or the direction of the detection target from a difference in vibration pattern.

In addition, the present invention is not limited to the aforementioned embodiment, and various modifications can be made without departing from the concept of the present invention, and all technical matters included in the technical idea described in the claims are included within the subject of the present invention. Although the above-mentioned embodiment shows a preferred example, those skilled in the art can realize various alternatives, alternations, modifications, or improvements from the contents disclosed in the present specification. These are included in the technical concept described in the appended claims.

For example, the present invention can also be applied to a remote operation terminal that communicates with the controller 150 to issue a command for remotely operating the crane 100. In addition, a control room where remote operation is performed can also be configured to notify the operation of the manipulation lever through vibration similarly. That is, the present invention can be applied to not only the turning lever 221 provided in the cab 109 but also all manipulation devices of cranes such as a turning dial in a remote operation terminal and a turning dial installed in a remote control room.

In addition, a crawler crane has been exemplified as an example of the crane. However, the present invention is not limited to this and can be applied to all kinds of cranes such as tower cranes, ceiling cranes, jib cranes, retractable cranes, stacker cranes, portal cranes, unloaders, and other basic machines such as earth drills, in addition to other mobile cranes such as wheel cranes, truck cranes, rough terrain cranes, and all terrain cranes.

Furthermore, since the vibration can be more clearly sensed than in the related art, the present invention is also applicable to work machines other than the cranes, such as hydraulic excavators and wheel loaders. In addition, the present invention can also be applied to transport machines (transport vehicles) such as automobiles and dump trucks.

It should be understood that the invention is not limited to the above-described embodiment, but may be modified into various forms on the basis of the spirit of the invention. Additionally, the modifications are included in the scope of the invention.

What is claimed is:

1. A manipulation device that manipulates a work machine, the manipulation device comprising:
a manipulating member that is gripped by an operator; and
a vibration unit that notifies the operator of a state of the work machine through vibration,
wherein the vibration unit constitutes a vibration system different from the manipulating member.

2. The manipulation device according to claim 1,
wherein the vibration unit includes a vibrator and a case that houses the vibrator, and
the case is made of an elastic body that damps the vibration of the manipulating member, and
the vibrator is housed in the case in a state where a part of the vibrator is exposed.

3. The manipulation device according to claim 2,
wherein the case includes a pair of upper and lower shaft portions, and the pair of shaft portions are pivotably supported by a pair of upper and lower shaft support portions provided below the manipulating member.

4. The manipulation device according to claim 1,
wherein the vibration unit includes a vibrator and a case that houses the vibrator and vibrates integrally with the vibrator, and
the case is attached to the manipulating member via a damping member that damps the vibration of the manipulating member.

5. The manipulation device according to claim 4,
wherein a part of the case having flexibility constitutes the damping member.

6. The manipulation device according to claim 1,
wherein the manipulating member is operable in a first direction and a second direction, and
the vibration unit includes a first vibration unit that operates based on the manipulating member being operated in the first direction and a second vibration unit that operates based on the manipulating member being operated in the second direction.

7. The manipulation device according to claim 6,
wherein one of the first vibration unit and the second vibration unit is provided at a position where a base of a thumb of the operator comes into contact, and the other is provided at a position where a little finger of the operator comes into contact.

8. The manipulation device according to claim 7,
wherein the first vibration unit and the second vibration unit are built in the manipulating member, and a tip of each of vibrators in the first vibration unit and the second vibration unit protrudes from a case.

9. The manipulation device according to claim 8,
wherein the manipulating member includes a gripping portion and a flange portion provided at a lower end of the gripping portion, and
the first vibration unit and the second vibration unit are provided on an upper surface of the flange portion.

10. The manipulation device according to claim 1,
wherein an operation pattern of the vibration in the vibration unit changes according to a state of the work machine.

11. The manipulation device according to claim 1,
wherein a vibration pattern in the vibration unit changes according to a speed detection target of the work machine.

12. The manipulation device according to claim 11,
wherein the vibration unit detects a speed of a turning body which is the speed detection target and a hoisting speed and a lowering speed of a hoisting drum which is the speed detection target.

13. A work machine comprising:
the manipulation device according to claim 1,
wherein the work machine is allowed to perform at least work other than traveling by the manipulation device.

14. A work machine comprising:
the manipulation device according to claim 1,
wherein the work machine is a transport machine that performs transport work.

15. The work machine according to claim 13, comprising:
an undercarriage that travels;
a turning body that is turnable with respect to the undercarriage;
a boom that is pivotally supported by the turning body; and
a hoisting rope that is allowed to be wound and unwound,
wherein the vibration unit is allowed to notify an operator of a state of the work machine related to operation of at least one of the undercarriage, the turning body, and the hoisting rope through vibration.
